(19) United States
(12) Patent Application Publication
(10) Pub. No.: US 2026/0162473 A1
(43) Pub. Date: Jun. 11, 2026

(54) METHOD FOR MANAGING VEHICLE RISK AND SERVER THEREFOR

(71) Applicant: HL MANDO CORPORATION, Gyeonggi-do (KR)

(72) Inventors: Yongwoo LEE, Gyeonggi-do (KR); Hoondow JANG, Gyeonggi-do (KR); Jaehyeon LIM, Gyeonggi-do (KR); Dasol KIM, Gyeonggi-do (KR)

(21) Appl. No.: 19/411,134

(22) Filed: Dec. 5, 2025

(30) Foreign Application Priority Data
Dec. 6, 2024 (KR) 10-2024-0180767
Dec. 1, 2025 (KR) 10-2025-0187540

(51) Int. Cl. G07C 5/08; G06F 21/57

(52) U.S. Cl. CPC G07C 5/0808; G06F 21/577; G06F 2221/034

(57) ABSTRACT

In a vehicle risk management method performed by a server, the method may include identifying a plurality of functional elements of the vehicle that have interrelationships and analyzing a plurality of asset elements of the vehicle to identify predicted threat scenario; deriving a target hazard scenario to be subjected to hazard evaluation based on at least one hazard situation element; deriving an impact scenario corresponding to the target hazard scenario and the predicted threat scenario and deriving an attack path based on the impact scenario; determining a safety level based on an exposure, a severity, and a controllability of the hazard situation for the target hazard scenario; and establishing a safety goal based on the target hazard scenario and the safety level and establishing a security goal of the vehicle based on the attack path and the predicted threat scenario.

### CROSS-REFERENCE TO RELATED APPLICATION

This application claims the benefit of Korean Patent Application Nos. 10-2024-0180767, filed on Dec. 6, 2024 and 10-2025-0187540, filed on Dec. 1, 2025 in the Korean Intellectual Property Office, the disclosure of which is incorporated herein by reference.

### BACKGROUND

### 1. Field

The disclosed invention relates to a vehicle risk management method and a server for performing the same.

### 2. Description of the Related Art

Among the various fields of the automobile industry, the most innovative and rapidly developing area since the 2000s has been the field of electrical and electronic systems. In particular, controllers that govern vehicle behavior have significantly contributed to road traffic safety by providing drivers with a more stable driving experience through more precise control enabled by advancements in vehicle semiconductors and embedded software. In addition, by offering convenience features for drivers, the marketability of vehicles has been further enhanced. Going beyond controlling engines or brakes, vehicles now provide smart keys, navigation systems, and various infotainment systems. Accordingly, multiple controllers in a vehicle communicate and exchange information with each other through the in-vehicle network.

Along with these advancements, the complexity of vehicle systems and the importance of safety continue to increase, but high-risk accidents caused by compound failures of electrical and electronic components intended to ensure software invisibility and availability are still being continuously reported.

To prevent such incidents, ISO 26262 was first published in 2011, revised in 2018, and has since been widely applied.

ISO 26262 is an international standard that addresses functional safety of electrical and electronic systems within a vehicle, prescribing a development process intended to prevent failures or malfunctions in such systems from leading to accidents. In addition, ISO 26262 focuses on quality assurance by enabling more accurate system design, precise analysis, and thorough verification and validation to ensure the safety of defined data, systems, and subsystems.

ISO 26262 requires a systematic approach that identifies safety requirements from the early stages of vehicle system development and ensures that these safety requirements are satisfied throughout the design, verification, and maintenance phases. For example, ISO 26262 mandates the performance of Hazard Analysis & Risk Assessment (HARA) to identify and assess vehicle-level hazards arising from product failures.

Meanwhile, with the increased robustness of individual vehicle controllers and advancements in communication technologies, cooperative control among in-vehicle controllers has rapidly progressed, and as infotainment systems have also advanced, the exposure of assets to potential threats has increased.

To prevent such threats, the cybersecurity standard ISO/SAE 21434 was established. ISO/SAE 21434 was structured closely to ISO 26262, one of the successful precedents, which significantly contributed to its rapid adoption.

ISO/SAE 21434 is an international standard that deals with vehicle cybersecurity, defining security requirements and development processes aimed at protecting a vehicle's electronic systems from external attacks.

ISO/SAE 21434 requires a comprehensive cybersecurity management framework that includes vehicle security threat analysis, risk assessment, security design, and the establishment of response plans. For example, ISO/SAE 21434 requires the identification and assessment of threats at the level of the vehicle and its components, such as systems, software, and hardware (also referred to as items), in order to respond to external cyberattacks. In other words, it requires the execution of Threat Analysis and Risk Assessment (TARA).

With the establishment of these standards, compliance with them has become an essential requirement throughout the automotive industry. Accordingly, companies manage functional safety and cybersecurity activities separately to perform the specialized tasks required by each standard.

In particular, for cybersecurity, some companies have dedicated departments to respond quickly to newly established European regulations. Furthermore, the distribution of requirements for vehicle development is carried out by different parties at different points in time.

Since ISO 26262 and ISO/SAE 21434 differ in their requirements and approaches, companies traditionally manage HARA and TARA separately to perform specialized work for each international standard.

In the case of HARA, many companies have traditionally created and managed documents using Excel-based forms, but to date, no software tool specialized for HARA has been developed. HARA derives hazard events by considering operational situations and/or malfunctions, and as the number of hazard events increases, the processing time for Excel VBA (Visual Basic for Applications) becomes longer, which is a disadvantage.

In addition, although an increasing number of companies are developing and commercializing software tools specialized for TARA, the majority still create and manage TARA using Excel-based forms.

Meanwhile, separate from HARA and TARA, companies are increasingly required—either internally or at the request of corporate clients—to produce fail-safe management (FSM) documents for vehicle fault safety management. An FSM document organizes the detection and reaction strategies for various product failures and summarizes the factors that affect the product, such as failures of data elements or failures of external interfaces. Since the processes of fault detection and transition to a safe state involve various technology development elements, the participation of multiple stakeholders in the drafting and review process is essential.

FSM documents may be created in spreadsheet or text-based formats and updated through configuration management tools. However, when using document-based configuration management tools, multiple stakeholders cannot easily work simultaneously, which is a limitation. Moreover, using structured formats such as spreadsheets or text documents has the drawback that, due to their inherent characteristics, they are difficult to adapt to specific templates or purposes.

### SUMMARY

The technical problem that the present invention aims to solve is to provide a vehicle risk management method and a server capable of integrating Hazard Analysis & Risk Assessment (HARA), Threat Analysis & Risk Assessment (TARA), and Fail-Safe Management (FSM).

The technical problem that the present invention aims to solve is to provide a vehicle risk management method and a server that offer an integrated software tool for HARA, TARA, and FSM.

The technical problem that the present invention aims to solve is to provide a vehicle risk management method and a server that enable consistent evaluation of the common portions shared between HARA and TARA.

The technical problem that the present invention aims to solve is to provide a vehicle risk management method and a server capable of outputting consistent results for common data by using an integrated database for the common data of HARA and TARA.

The technical problem that the present invention aims to solve is to provide a vehicle risk management method and a server that allow HARA, TARA, and FSM to be carried out simultaneously even in situations where available resources are limited.

The technical problem that the present invention aims to solve is to provide a vehicle risk management method and a server that ensure consistency across the respective output results of HARA, TARA, and FSM based on an integrated database and improve efficiency, including resource reduction.

The technical problem that the present invention aims to solve is to provide a vehicle risk management method and a server capable of outputting the respective results of HARA, TARA, and FSM in templates suitable for their intended purposes.

The technical problem that the present invention aims to solve is to provide a vehicle risk management method and a server capable of outputting results that conform to formats suggested by ISO for DTC (Diagnostic Trouble Code), such as GMRDB, or OEM-specific templates when needed, by using an integrated database to generate output matching the required template.

According to an aspect of the disclosed invention, a vehicle risk management method may include identifying a plurality of functional elements of the vehicle have interrelationships, analyzing a plurality of asset elements of the vehicle, and identifying a predicted threat scenario; deriving a target hazard scenario that is subject to risk evaluation based on at least one hazard situation element; deriving an impact scenario based on the target hazard scenario and the predicted threat scenario, and deriving an attack path based on the impact scenario; determining a safety level based on an exposure, a severity, and a controllability of the hazard situation for the target hazard scenario; and establishing a safety goal based on the target hazard scenario and the safety level, and establishing a security goal of the vehicle based on the attack path and the predicted threat scenario.

The target hazard scenario may be derived by combining at least one hazard situation element relating to an operating mode, operational situation, and an environmental condition of the vehicle, and excluding contradictory combinations among the combined hazard situation elements.

The plurality of functional elements may include at least one of a function of the vehicle, a malfunction of the function, and a hazardous state that may occur due to the malfunction.

The plurality of asset elements may include an asset to be protected, a function of the asset, and a property of the asset, wherein the function of the asset corresponds to the function of the vehicle, and a safety hazard caused by a malfunction of the vehicle corresponds to a security risk caused by the compromise of the function of the asset.

The impact scenario may be derived by analyzing the malfunction of the function among the plurality of functional elements identified in the target hazard scenario, evaluating the hazardous state caused by the malfunction, and simulating the influence of the hazardous state on driver or the vehicle.

The attack path may be generated based on at least one of a safety element, a financial element, an operational element, and a privacy element for the impact scenario, and wherein the safety element is derived from the safety level.

The safety level may be determined by evaluating the exposure, severity, and controllability of the hazard situation according to predefined evaluation criteria and combining the results of the evaluations of the exposure, severity, and controllability.

The security goal is set to satisfy a required level of integrity and availability demanded by the safety goal.

Based on the security goal, security control measures and alternative security measures are determined to satisfy conditions of the safe state.

The vehicle risk management method may further comprise setting diagnostic control logic, safety mechanisms, and security management measures to achieve the safety goal and the security goal of the vehicle, wherein setting the diagnostic control logic comprises: defining risk conditions for determining functional failures and security threats of the vehicle, and setting parameters used for determining the risk and storing the parameters in a database; and extracting diagnostic information and response-related information associated with the functional failures and security threats of the vehicle based on the parameters, and storing the diagnostic information and the response-related information in the database to be used as input data for risk assessment.

For identical or similar target hazard scenario or predicted threat scenario, an application results of the security management measures and the application results of the safety mechanisms are matched with each other and configured to be linked or managed in the database.

According to one aspect of the disclosed invention, a server may comprise a database storing a plurality of data for vehicle risk management, a communication module configured to communicate with an external device, and a processor electrically or communicatively connected to the database and the communication module, wherein the processor is configured to: identify a plurality of functional elements of the vehicle that have interrelationships and analyze a plurality of asset elements of the vehicle to identify predicted threat scenario; derive a target hazard scenario, which is subject to hazard evaluation, based on at least one hazard situation element; derive an impact scenario corresponding to the target hazard scenario and the predicted threat scenario, and derive an attack path based on the impact scenario; determine a safety level based on an exposure, a severity, and a controllability of the hazard situation for the target hazard scenario; and establish a safety goal based on the target hazard scenario and the safety level, and establish a security goal based on the attack path and the predicted threat scenario.

The target hazard scenario may be derived by combining the at least one hazard situation element related to an operating mode, operational situation, and environmental condition of the vehicle, and excluding contradictory combinations among the combined hazard situation elements.

The plurality of functional elements includes at least one of a function of the vehicle, a malfunction of the function, and a hazardous state that may occur due to the malfunction.

The plurality of asset elements includes an asset to be protected, a function of the asset, and a property of the asset, and wherein the function of the asset corresponds to the function of the vehicle, and a safety hazard caused by a malfunction of the function of the vehicle corresponds to a security risk caused by the compromise of the function of the asset.

The impact scenario may be derived by analyzing the malfunction of the function among the plurality of functional elements identified in the target hazard scenario, evaluating the hazardous state caused by the malfunction, and simulating the influence of the hazardous state on the driver or the vehicle.

The attack path may be generated based on at least one of a safety element, a financial element, an operational element, and a privacy element for the impact scenario, and wherein the safety element is derived from the safety level.

The safety level may be determined by evaluating the exposure, severity, and controllability of the hazard situation according to predefined evaluation criteria and combining the results of the evaluations of the exposure, severity, and controllability.

The processor may be configured to set diagnostic control logic, safety mechanisms, and security management measures to achieve the safety goal and the security goal of the vehicle; define risk conditions for determining functional failures and security threats of the vehicle, set parameters used for determining the risk, and store the parameters in the database; extract diagnostic information and response-related information associated with the functional failures and security threats of the vehicle based on the parameters, and store the diagnostic information and the response-related information in the database to be used as input data for risk assessment, thereby setting the diagnostic control logic.

The processor may be configured such that, for identical or similar target hazard scenarios or predicted threat scenarios, the results of applying the security management measures and the results of applying the safety mechanisms are matched with each other and are associated with or managed in the database.

It is an objective of certain embodiments of the present invention to address, alleviate, or at least partially resolve at least one of the problems and/or disadvantages associated with the related art. Certain embodiments are intended to provide at least one of the advantages described below.

According to one aspect of the disclosed invention, the vehicle risk management method and the server provided for performing the method may offer a technology that integrates Hazard Analysis & Risk Assessment (HARA), Threat Analysis & Risk Assessment (TARA), and Fail-Safe Management (FSM).

According to one aspect of the disclosed invention, the vehicle risk management method and the server provided for performing the method may provide a software program that integrates HARA, TARA, and FSM.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram illustrating an integrated system for vehicle risk management according to an embodiment;

FIG. 2 is a diagram illustrating a step-by-step analysis procedure and relational structure for safety hazards and security threats according to an embodiment;

FIG. 3 is a diagram exemplifying common data for safety hazards and security threats according to the embodiment of FIG. 2;

FIG. 4 is a block diagram of an integrated vehicle risk management system according to an embodiment;

FIG. 5 is a flowchart illustrating a control operation procedure of a server according to an embodiment; and

FIG. 6 is a flowchart illustrating a control procedure of a server for achieving vehicle safety goals and security goals according to an embodiment

### DETAILED DESCRIPTION

Throughout the specification, the same reference numerals refer to the same components. The specification does not describe every element of the embodiments, and general or overlapping content within the technical field of the disclosed invention is omitted. The terms “unit, module, member, block” used in the specification may be implemented in software or hardware. Depending on the embodiments, multiple “units, modules, members, blocks” may be implemented as a single component, or one “unit, module, member, block” may include multiple components.

Throughout the specification, when a part is described as being “connected” to another part, this includes not only cases where they are directly connected but also cases where they are indirectly connected, and indirect connection includes connection via a wireless communication network.

In addition, when a part is described as “including” an element, this means that, unless explicitly stated otherwise, the part may include additional elements rather than excluding other elements.

Throughout the specification, when a member is described as being “on” another member, this includes not only cases where the member is in contact with the other member but also cases where another member is interposed between the two.

The terms first, second, and so forth are used solely to distinguish one component from another and do not limit the components by these terms.

Singular expressions include plural forms unless the context clearly indicates otherwise.

Reference numerals for steps are used for convenience of description and do not indicate the order of the steps. Unless the context explicitly requires a particular sequence, the steps may be performed in an order different from that described.

ISO 26262 and ISO/SAE 21434 both present activities for identifying and mitigating risks and threats related to vehicles and drivers, and they share similarities in their development stages. Accordingly, research has begun on providing a unified procedure and framework based on the similarities and alignment between Threat Analysis & Risk Assessment (TARA), which serves as the starting point of cybersecurity activities, and Hazard Analysis & Risk Assessment (HARA), which serves as the starting point of functional safety activities.

However, depending on the level of concreteness of each vehicle asset, the quality of analysis results may vary, and the level of detail required for security controls to mitigate threats may also differ. Therefore, simply pursuing research at the concept-development level may make it difficult to apply a unified process.

In this regard, considering that security controls may correspond to or be in an inclusion relationship with safety mechanisms or safety measures in functional safety, the disclosed invention aims to identify the major common information contained in TARA and HARA, define the relationships between them, and propose a framework that enhances the efficiency of utilizing each other's information.

Additionally, ISO 26262 and ISO/SAE 21434 have become essential requirements that must effectively be met to sell products in the market, as they are tied to product liability laws and vehicle type-approval regulations. This has been a major factor driving the widespread adoption of both standards across the automotive industry.

However, companies that are applying functional safety or cybersecurity for the first time, or have only applied them in a limited manner, face significant challenges in identifying the differences between their existing development practices and the methodologies required by the standards and in unifying them into an efficient process. In particular, in cases where regulations such as UNECE R155 have been rapidly enacted, meeting the regulatory requirements has become a more urgent task than unifying and internalizing the processes.

Due to the urgency of meeting such requirements, attention and importance placed on the original purpose for which the standards were established tend to diminish. As a consequence, the qualitative maturity of each standard does not grow sufficiently, and individual activities isolate information flow, reduce consistency, and decrease resource efficiency, thereby hindering improvements in development quality.

Therefore, to prevent serious incidents such as unintended acceleration or vehicle theft and to enhance development quality, it is necessary to unify the segmented activities required by each standard.

The concept-development domains required by each standard are often not properly executed due to ambiguous role separation between vehicle manufacturers and their first-tier suppliers (also referred to as Tier 1 suppliers). As a result, vehicle manufacturers may simply adopt what the supplier provides, or conversely, Tier 1 suppliers may follow what the manufacturer provides, without proper execution of the required activities.

Both cybersecurity and functional safety begin with concept development, and if detailed structuring is not established at this stage, it becomes difficult to improve the quality and maturity of subsequent development.

Accordingly, the disclosed invention aims to propose a foundation for unifying processes by identifying the common input deliverables, processes, and outputs of TARA and HARA, which are methods for identifying risks and threats during concept development.

Meanwhile, in both TARA and HARA, it is important to clearly understand the design intent of the product, its corresponding functions, and the performance targets required for those functions to be realized. Through this, threats required by each standard can be effectively identified, and optimized risk-mitigation activities can be carried out within the available resources.

TARA primarily analyzes cyber-security threats, focusing on attack paths and external interfaces, whereas HARA focuses on system functional malfunctions and their implications for safety.

A key preliminary deliverable commonly required in both TARA and HARA is the data definition document. This document defines the functional and physical characteristics of the system under analysis, as well as the boundary conditions of the vehicle system, and serves as an essential foundational asset for performing both TARA and HARA.

The main components of the data definition document may include definitions of system boundaries, operational environments, regulatory requirements, and system functions.

Clearly defining the boundaries and interfaces of the vehicle system is critical for both TARA and HARA. This is necessary to determine the scope within which functional malfunctions may have an impact, and to accurately understand how external factors may affect the vehicle system. In particular, it is essential for evaluating how interactions between vehicle systems affect overall safety and security.

To achieve this, the likelihood of attack for each possible attack path must be assessed, and all external interfaces must be thoroughly identified. It is especially important to clearly define the purpose and type of each interface, as a lack of understanding of the information flow related to communication or control processing components makes it difficult to assess the severity and priority of threats. In both TARA and HARA, identifying system boundaries and interfaces is a core task commonly required to comprehensively evaluate system security and safety.

In addition, the various operating modes of a system and its environmental conditions significantly influence both the likelihood and severity of potential hazardous situations. For example, the risk factors during high-speed driving may differ from those during low-speed driving, and vehicle operation under certain environmental conditions, such as severe weather, may introduce additional hazards. Therefore, it is important to identify all possible operating modes and environmental conditions of the vehicle and thoroughly understand how the system behaves in each scenario. This provides essential information for evaluating exposure frequency and controllability.

In practice, the functions manifested by data may differ depending on operating environments and operating conditions, and the potential exposure to cybersecurity threats arising from communication between controllers or from connections with external systems may also differ. For instance, during certain operating modes or circumstances in the vehicle's life cycle, access to or manipulation of specific information may be restricted, and as a result, the likelihood of threats may vary. Some modes may only be active for short periods, whereas features such as FOTA (Firmware Over the Air) occur periodically but may not be vulnerable to real-time threats. Therefore, the critical information and communication channels for each operating mode must be identified before conducting TARA, as this is an essential preparatory activity for ensuring system security and safety.

As mentioned previously, HARA analyzes system functional malfunctions and the risks associated with those malfunctions. To do so, it is necessary to clearly understand the product's design intent, its applicable functions, the means by which those functions are implemented, and the performance targets required for those functions to manifest. Through this understanding, potential hazardous situations can be identified, and appropriate safety goals can be established.

TARA, on the other hand, analyzes malicious threats that may arise from intentional attacks. Accordingly, TARA evaluates the threats that may occur when the system is intentionally manipulated or attacked and focuses on setting appropriate security countermeasures.

Functional definitions included in the data definition document that apply to both TARA and HARA can serve as an important foundational resource for systematically identifying potential hazards and for setting safety and security goals.

Additionally, TARA has limitations in that identifying assets and understanding data flows based solely on the preliminary architecture level is difficult. Assets that rely on software are challenging to identify internally, and without a clear understanding of data flows, the importance of threats cannot be accurately evaluated. To address this, external interfaces and communication paths must be clearly identified, and defense-in-depth principles should be applied.

In practice, TARA faces significant limitations in identifying assets at the preliminary architecture stage. This is due to the fact that cybersecurity assets rely heavily on software, and it is particularly difficult to identify assets such as specific encryption algorithms or cryptographic keys.

For example, when data is part of a vehicle black box, there may be limitations in identifying internal assets aside from interfaces with external elements. This results in constraints during the asset-derivation process and necessitates more detailed system information. Additionally, TARA may face limitations in assessing the importance of threats when data flows are not clearly identified.

If data flows are not clearly defined, it becomes difficult to evaluate the significance of threats. TARA requires assessing the likelihood of attacks for each possible attack path, and for this purpose, identifying all external interfaces and clearly defining the purpose and type of each interface is essential. Without identifying communication paths and control-processing routes, the severity and importance of threats cannot be accurately evaluated.

Furthermore, TARA must also consider the hierarchy of communication signals when a single signal affects multiple functions, as accurate assessment is not possible otherwise. Therefore, following the principles of defense in depth, it is necessary to clearly identify the location of controllers within each layer of the vehicle network, which enables the implementation of effective cybersecurity controls at the vehicle level.

Meanwhile, a limitation of HARA is that it has constraints in analyzing malfunctions that reflect cybersecurity propertys. Malfunctions caused by malicious attacks must also be identified as hazardous events, and it is important to recursively analyze the risks that may arise if security functions fail.

In conventional HARA, the analysis of malfunctions that do not incorporate cybersecurity propertys becomes a critical factor. To identify hazardous events, it is essential to analyze the high-level effects caused by product failures. This analysis must include not only systematic or random hardware failures addressed in traditional functional safety, but also malfunction scenarios caused by malicious attacks, which must likewise be identified as hazardous events and systematically organized into a library.

Additionally, in HARA, identifying hazardous events that may arise from cybersecurity functions is also required. Cybersecurity control functions are introduced through TARA as measures to reduce risks associated with certain assets and are often applied as new functions. Therefore, based on the functions defined in the data definition document, hazardous events that may occur if such functions malfunction must be derived.

This process requires recursive analysis, where it becomes important to analyze vehicle behavior and associated risks in the event that a cybersecurity function fails and to identify the resulting events.

Based on the above, it can be seen that various aspects of cybersecurity and functional safety risk-management methods require harmonization. Moreover, beyond simple harmonization, the limitations of TARA and HARA are interrelated, indicating the need for them to eventually be integrated into a unified system.

In practice, the need for consistent evaluation and integrated risk management across HARA and TARA has long been recognized.

Furthermore, based on the relationship between HARA and TARA, integrated management of safety mechanisms and security control functions through a common database and recursive analysis is also required.

The impact assessment or damage scenarios performed in TARA are closely related to the malfunctions and hazardous events identified in HARA, as well as the severity propertys used to evaluate them. To ensure that these relationships can be assessed as common product properties, the need has emerged to set a consistent evaluation framework between the two methodologies through a unified system.

Failures caused by attacks ultimately lead to hazardous events, and based on this interrelationship, a unified evaluation method using a single integrated database has been required. This enables consistent risk assessment within the system and is essential for effectively linking the results of each analysis methodology.

According to the process flow for performing HARA and TARA, the outputs of both methodologies may be re-identified as safety mechanisms or security control functions, which can be reconstructed as functions within the data definition document.

This relationship indicates that recursive analysis is needed through a unified database, as described above, and ultimately suggests the necessity for an integrated risk management approach. Therefore, in complex systems where functional safety and cybersecurity elements interact, consistent risk management must be achievable through a unified approach.

Furthermore, considering functional safety propertys such as systematic faults or random hardware failures during threat analysis and preventing malicious attacks by hackers during hazard analysis ultimately converge on the same purpose of preventing system failures.

Accordingly, the disclosed invention aims to propose a technology that organizes the common areas and individual requirements of TARA and HARA based on the analysis flows required by ISO/SAE 21434 and ISO 26262, clarifies the interconnections between them, and enables integrated management and utilization.

More specifically, the disclosed invention aims to propose a technology that integrates HARA required for functional safety and TARA required for cybersecurity, provides a process for performing integrated cross-analysis on assets and functions, and extends the integrated risk-management procedure for cybersecurity and functional safety by considering safety analysis along with vehicle development, operation, and the entire life cycle.

Hereinafter, the operational principles and embodiments of the disclosed invention will be described with reference to the accompanying drawings.

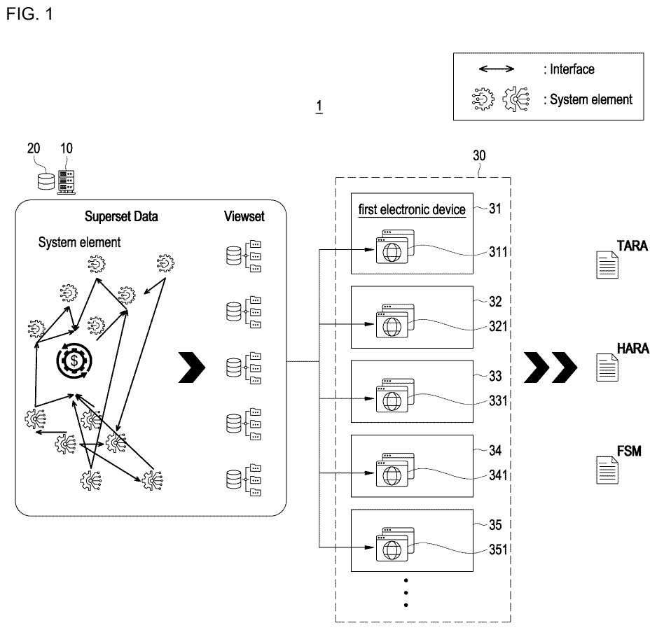

FIG. 1 is a diagram illustrating an integrated system for vehicle risk management according to an embodiment.

Referring to FIG. 1, the vehicle risk integrated management system 1 may include a server 10 and one or more clients 30, for example, first through fifth electronic devices 31, 32, 33, 34, and 35.

The server 10 may provide a web-based service that enables consistent evaluation of common areas by integrally managing HARA, TARA, and FSM documents.

The server 10 may store pre-designated and registered assets, functions, system elements of a vehicle, and interface information (also referred to as connection information).

The server 10 may include a database 20, and the database 20 may store assets, functions, system elements of the vehicle, and interface information.

The assets may be one or more and may include hardware and software configurations of the vehicle. They may be additionally registered or deleted. For example, the assets may include vehicle data assets, communication assets, control assets, hardware assets, software assets, authentication and security assets, and user interface assets.

The functions may be one or more and may represent the services provided to the user by the vehicle or its configuration (hardware and/or software).

The system elements may be one or more and may include hardware and/or software components of the vehicle.

The interface information may include information representing the connection relationships between the vehicle's assets and/or functions and the system elements.

The server 10 may structure text-based data and interconnect each piece of data (also referred to as information), and may organize the relationships and structured information of the interconnected data into viewsets. The server may then transmit the resulting data to electronic devices 31, 32, 33, 34, and 35.

For example, the server 10 may structure each text-based data item regarding assets, functions, and/or system elements and may organize the relationships and structured information of each text-based data into a viewset based on interface information, then transmit it to electronic devices 31, 32, 33, 34, and 35.

In response to information (also referred to as data) received from electronic devices 31, 32, 33, 34, and 35, the server 10 may generate and output HARA, TARA, and/or FSM output data based on the assets, functions, system elements, and/or interface information.

For example, when the server 10 receives asset information or function information and additional user input data (also referred to as user input information) from an electronic device 31, 32, 33, 34, or 35 that has received the data provided by the viewset, the server may generate HARA, TARA, and/or FSM output data corresponding to the relevant asset or function and transmit the generated output data to that electronic device.

HARA is for ensuring the functional safety of a vehicle, evaluating potential hazards that may occur under various operating conditions, determining the top-level safety goals, and based on these goals, determining the Automotive Safety Integrity Level (ASIL). In the process of determining the ASIL, various operating conditions may be parameterized and utilized.

TARA evaluates cybersecurity for a vehicle, more specifically the threats and risks within the vehicle. It may analyze these by considering the functions of the relevant components within the vehicle (for example, the controller involved) and/or signals (for example, CAN signals).

For example, TARA may identify threat factors related to financial loss, safety issues that may cause vehicle accidents and/or occupant injury, operational disruptions that may affect vehicle operation and/or functionality, and privacy risks involving personal data leakage and/or compromise.

Among the threat factors in TARA, the safety-related factors may be analyzed with reference to the hazardous events identified in HARA.

The ultimate purpose of TARA is to identify security goals for the threats identified in the system and derive security control techniques that can mitigate them.

An FSM document organizes the detection and reaction strategies for various product failures and describes the elements that may affect the product, such as failures of data elements or failures of external interfaces.

The FSM document may include information on cybersecurity controls identified in TARA and information on safety mechanisms derived through multiple processes identified in HARA.

HARA, TARA, and FSM documents may include common areas shared among them, as well as areas specific to each.

Meanwhile, the server 10 may have the following conditions predesignated and stored regarding data usage, thereby ensuring the integrity of working data.

### <Conditions>

1. General users among the predefined users cannot enter data.
2. General users cannot write any data other than the data already entered.
3. Only a master user with write permission can enter data.

The server 10 may store data-connection information in advance. Accordingly, when specific information is selected by an electronic device 31, 32, 33, 34, or 35, the connected information may automatically be provided and displayed on that electronic device. Alternatively, all propertys of the table linked to the selected information may be provided and displayed on the electronic device 31, 32, 33, 34, or 35, and the user of that electronic device may directly select the propertys.

Additionally, the server 10 may store information requiring calculation and formulas predesignated to be associated with such information. For information requiring calculation, the server may automatically compute the result using the stored formulas and provide and display the result on the electronic devices 31, 32, 33, 34, and 35.

The server 10 may provide an approval service.

For example, the server 10 may provide an approval service to confirm that finalized information has no further changes after review and inspection between a general user and a master user.

Once the approval process is completed, the corresponding information (for example, an approved viewset) cannot be modified. If changes are needed, an approval request to unlock the data must be submitted.

The server 10 may provide a mailing service.

As a notification function, a mailing service for at least one piece of information may be predesignated in the server 10, and the server may provide the mailing service through communication with a predesignated mail server.

The server 10 may perform data visualization. The server 10 may visualize analytical information such as functional analysis and fault analysis through a structure tree and provide it to the electronic devices 31, 32, 33, 34, and 35.

The server 10 may set and store different user permissions for each user.

For example, the users may include administrators, master users, general users, and associate users. Each user may be distinguished by a user ID (Identifier).

The administrator may have permissions enabling the execution of all possible user activities. For example, the administrator may be able to register or delete users, modify user permissions, and manage data modification. The administrator may also input, edit, and delete bulk data from the administrator page. In addition, the administrator may perform a rollback operation, which cancels ongoing transactions and restores modified data to its original state. The administrator may also modify the dashboard that appears as the first screen upon login.

A master user may have permissions set to allow reading or modifying data within the assigned project. Depending on the project, the master user's data viewing or editing rights may be restricted, and delete permissions may not be granted. The master user may also be granted separate permissions to review viewsets created by general users.

A general user may have permissions to view and modify data within the assigned project. However, in projects where permissions are not granted, the general user's ability to view or modify data may be restricted, and delete permissions may not be granted. The general user may also be given separate permissions to review viewsets created by the master user.

An associate user may have permissions limited to reading and exporting viewsets. For example, the associate user may be permitted only to read and export viewsets and may not perform any other functions.

For example, the server 10 may set and store a predefined permission configuration for each user type, as shown in Table 1.

TABLE 1

| User Type | User Permissions |
|---|---|
| Administrator | Read, Write, Modify, Clear, Import, |
| | Export, Submit, and Approval |
| Master User | Read, Modify, Export, and Approval |
| General User | Read, Modify, Export, and Approval |
| Associate User | Read and Export |

In Table 1, “Read” means that the user can read data from projects for which permissions have been granted.

“Write” means that the user can add new entries to the data of a project for which write permission has been granted. However, according to the predefined settings, data may be added only to the “Superset.”

“Modify” means that the user can change existing data in a project for which modification permission has been granted. For example, the user may select and change data through a dropdown box among the graphical user interface (GUI) elements displayed on the screen of the electronic devices 31, 32, 33, 34, and 35.

“Clear” means that the user can delete data, including cases where data inside a Superset project is deleted.

“Import” means that data can be loaded into the Superset project through a file in a predefined format, such as an Excel file or a CSV file.

“Export” means that the contents of a viewset of a project for which permission has been granted can be output or saved in a predefined format, such as Excel, Word, or PDF.

“Submit” means that, after completing the evaluation for HARA or TARA, the user may submit the corresponding viewset to request approval. For example, when a Functional Safety activity is completed, the viewset for that activity may be submitted for approval.

“Approval” means that the evaluated HARA or TARA viewset can be reviewed and approved.

Each of the electronic devices 31, 32, 33, 34, and 35 may receive web-based services from the server 10. A web browser 311, 321, 331, 341, and 351 may be installed on each electronic device, and through the respective web browser, the user may access and use the web-based services of the server 10.

Each of the electronic devices 31, 32, 33, 34, and 35 may display screens corresponding to the web-based services of the server 10 and, through user input, may select items for generating HARA, TARA, or FSM documents corresponding to the assets or functions of the vehicle, and transmit the selected data to the server 10.

Additionally, each of the electronic devices 31, 32, 33, 34, and 35 may receive HARA, TARA, and/or FSM output data related to vehicle assets or functions from the server 10 and display it on the screen or output HARA, TARA, and/or FSM as output data.

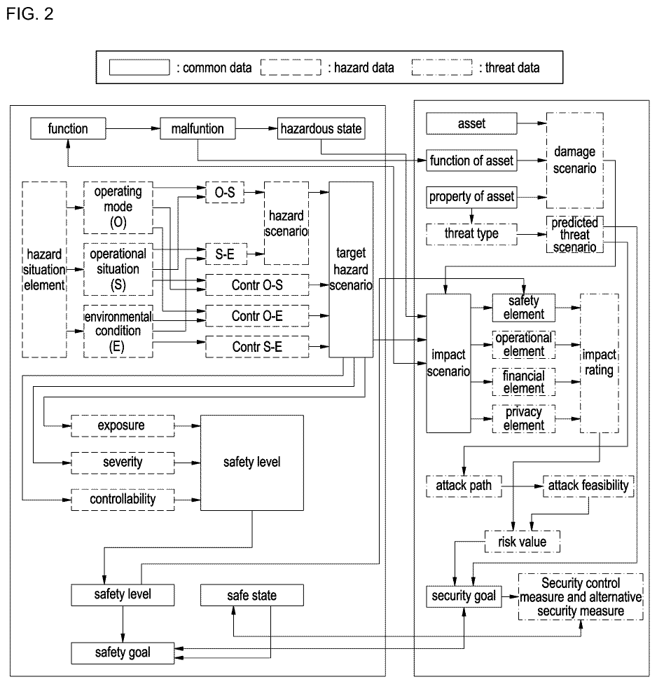

In an embodiment of the present invention, the respective steps of HARA and TARA have interrelationships as shown in FIG. 2, and through this, the vehicle system can simultaneously consider both safety and security.

Furthermore, HARA and TARA include procedures for evaluating each item of information and data based on the interconnected information and data.

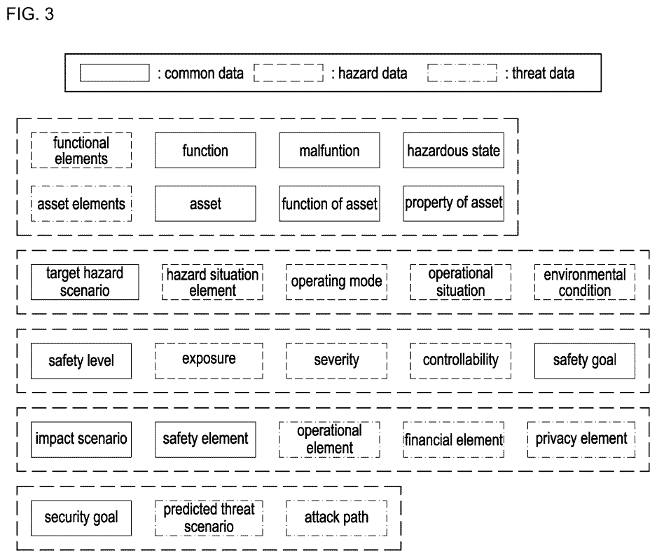

Furthermore, as illustrated in FIGS. 2 and 3, HARA and TARA may be classified into common information and data that can be standardized and generalized across both analyses, HARA-specific information and data dedicated to HARA, and TARA-specific information and data dedicated to TARA, and these classifications may be predefined.

FIG. 2 is a diagram illustrating a step-by-step analysis procedure and relational structure for safety hazards and security threats according to an embodiment.

As shown in FIG. 2, the vehicle risk analysis procedure according to an embodiment includes a data-flow structure that interlinks the analysis results of functional safety (HARA; Hazard Analysis and Risk Assessment) and cybersecurity (TARA; Threat Analysis and Risk Assessment) to establish integrated safety goals and security goals.

The data flow shown on the left side of FIG. 2 corresponds to HARA, the functional safety analysis procedure, and the data flow shown on the right side corresponds to TARA, the cybersecurity analysis procedure. Each of the two data-analysis flows may be divided into common data, hazard data, and threat data, and the respective data may form reference and linkage relationships with one another.

First, the procedure and relationships of HARA for functional safety are described.

In HARA, data related to the vehicle's function, malfunctions of the function, and hazardous events that may occur due to the malfunctions are defined as hazard data. HARA performs hazard evaluation based on the causal relationships among these elements. The vehicle functions may correspond to the asset functions used in the TARA procedure described later.

For example, one of the major functions of a vehicle, the “Requesting acceleration” function, is configured to control the vehicle's driving torque according to the driver's pedal input signal. However, if the function does not operate normally and instead a malfunction occurs in which excessive acceleration torque is requested beyond what is required, the vehicle may reach a state of unintended longitudinal acceleration, independent of the driver's intention.

Such a malfunction directly affects the driving stability of the vehicle and may be classified as a hazardous event that threatens the safety of the occupants. Accordingly, within the HARA procedure, the causal relationships among functions and the process of hazard propagation are analyzed to provide the foundational data for the hazard assessment performed in subsequent stages.

Based on at least one hazard situation element, a target hazard scenario to be subjected to hazard evaluation may be derived. The target hazard scenario may model a representative operational situation that can occur during driving of the vehicle and may be generated by combining at least one hazard situation element related to the operating mode of the vehicle, the operational situation, and the environmental condition. The target hazard scenario may be derived by combining the operating mode, the operational situation, and the environmental condition of the vehicle while excluding combinations that are contradictory or unrealistic. For example, when the operating mode of the vehicle is “highway driving,” the operational situation is “accelerating while the vehicle ahead maintains a constant speed,” and the environmental condition is “flat, paved dry asphalt road,” such a combination may be derived as a realistic scenario subject to hazard evaluation.

Specifically, referring to FIG. 2, a hazard scenario may be constructed by combining at least two items among the operating mode (O), the operational situation(S), and the environmental condition (E). For example, a hazard scenario may be derived by combining the operating mode (O) and the operational situation (S). Similarly, a hazard scenario may also be derived by combining the operational situation(S) and the environmental condition (E).

The operating mode (O), operational situation(S), and environmental condition (E) of the vehicle may each act as an independent hazard factor, However, in actual driving environments, these elements may influence one another, and a realistic hazard scenario may be set only under specific combinations.

Accordingly, as shown in FIG. 2, the mutual constraint relationships among the hazard situation elements may be defined as an operating mode-operational situation constraint relationship (Contr O-S), an operating mode-environmental condition constraint relationship (Contr O-E), and an operational situation-environmental condition constraint relationship (Contr S-E).

Here, Contr O-S represents a relationship for verifying whether a given combination between the operating mode and the operational situation is feasible. For example, when “highway driving mode” is combined with a “low-speed congested situation,” such a combination may be judged as contradictory and unlikely to occur simultaneously in practice, and therefore may be excluded from the hazard scenario.

Furthermore, Contr O-E represents a relationship for evaluating the controllability between the operating mode of the vehicle and the environmental condition. For example, when the vehicle enters an “automatic parking mode” and a “steep uphill or downhill road condition” is detected, such a case may be classified as a situation that is difficult for the system to control, and the need for additional safety control or countermeasures for uncontrollable conditions may be evaluated.

In addition, Contr S-E represents a relationship for evaluating the controllability between the operational situation and the environmental condition. For example, when a “vehicle acceleration situation” occurs while an “icy road surface condition” is detected, the scenario may be evaluated as having significantly low controllability and may be classified as a hazard situation with a low controllability class.

Accordingly, based on these mutual constraint relationships (Contr O-S, Contr O-E, and Contr S-E), only combinations that are feasible in real driving environments may be selected to derive the target hazard scenarios, while contradictory or unrealistic combinations may be excluded, thereby enabling more reliable hazard evaluation.

For example, when the vehicle is traveling straight at 80 km/h on a highway, the preceding vehicle is maintaining a constant speed, and the driver intends to accelerate, such conditions may be defined as a “target hazard scenario in which unintended longitudinal acceleration may occur due to a malfunction of the acceleration request function.” Subsequently, combinations that are contradictory among the hazard situation elements, such as “the road type is unpaved while the driving mode is set to highway driving,” or “the driver intends to decelerate while an acceleration malfunction occurs,” may be excluded from the hazard scenario due to their low likelihood of occurring in practice. As a result, a realistic and assessable target hazard scenario may be derived.

For the derived target hazard scenario, a safety level (ASIL) may be determined based on the exposure (E), severity(S), and controllability (C) of the hazard situation. The safety level may be derived by evaluating the exposure, severity, and controllability of the hazard situation according to predefined evaluation criteria and combining the evaluation results.

Specifically, in an embodiment of the present invention, the determination of the safety level may be performed based on the functional safety evaluation procedure defined in the ISO 26262 standard. The exposure (E) represents an indicator of the likelihood that a particular hazard situation will occur in an actual driving environment and may be calculated by comprehensively considering factors such as the vehicle's driving frequency, road conditions, climate conditions, and the driver's driving habits. For example, when the vehicle is driving on a highway under clear weather with a dry road surface, such conditions may be evaluated as a frequently occurring situation in real-world driving environments and may be classified as exposure class E4 (High probability situation).

he severity(S) is an indicator for evaluating the potential degree of harm to the occupants, the vehicle, and surrounding objects when the hazard situation actually occurs, and may be determined by considering physical variables such as the type of collision, collision speed, collision direction, initial inter-vehicle distance, and acceleration. For example, when a vehicle driving at the same speed as the preceding vehicle (80 km/h) receives an excessive acceleration request signal from the rear such that the inter-vehicle distance rapidly decreases, a collision may occur, potentially causing minor injuries to the occupants. Such a situation may be evaluated as severity class S1 (minor injuries).

Controllability (C) is an indicator used to evaluate the driver's ability to perceive and avoid or control the hazard situation, and may be calculated by considering factors such as the driver's reaction time, driving skills, and whether a warning system is activated. For example, when the driver perceives the decreasing distance from the preceding vehicle and immediately releases the accelerator pedal or performs braking, the situation may be regarded as easily controllable by the driver and may be classified as controllability class C1 (simply controllable).

By combining the evaluation results of the exposure (E), severity(S), and controllability (C), the safety level (ASIL) corresponding to the hazard situation may be determined in an embodiment of the present invention. For example, when the combination is evaluated as E4 (high probability), S1 (minor severity), and C1 (simply controllable), the corresponding hazard may be evaluated as relatively low risk and may be classified as QM (Quality Management) or ASIL-A. The safety level determined as described above may be used as a reference value for defining the strength and scope of functional safety measures when establishing the safety goal.

According to an embodiment, a safety goal of the vehicle may be established based on the target hazard scenario and the safety level. Specifically, the safety goal according to this embodiment may be defined as a criterion for preventing, in advance, hazard situations that may occur due to a malfunction of a vehicle function, or for minimizing injury and system damage even if such a hazard occurs.

The establishing of the safety goal may be based on the ASIL grade determined for each target hazard scenario, and stricter safety control and diagnostic requirements may be imposed as the ASIL grade increases. For example, when the “acceleration request function” of the vehicle malfunctions and an excessive acceleration torque is generated beyond the driver's intention, the corresponding target hazard scenario may be defined as “unintended longitudinal acceleration.” In this case, based on the determined ASIL grade, safety goals such as the following may be established. For example, when unintended acceleration is detected, the safety goal may require that the acceleration control signal be immediately cut off within 500 ms. Additionally, in the same situation, a notification function for promptly informing the driver and the relevant vehicle control modules (for example, an ECU) of the hazard occurrence may be included in the safety goal. Furthermore, when unintended acceleration is detected, the vehicle may automatically transition to a mitigation mode in which deceleration or functional limitation is applied, and the safety goal may specify that additional fallback control measures be executed, such as pressure limitation, deactivation of related functions, or alternative control.

To achieve the safety goal, a fault tolerance time interval and a safe state may be defined for each vehicle function. For example, for the acceleration control function, the fault tolerance time interval may be set to 500 ms. In this case, when an abnormal torque is detected within the specified time, the system may immediately output a warning signal to the driver and cut off the acceleration control signal through the vehicle control module, thereby transitioning the vehicle to the safe state.

The safety goal established as described above may serve as a top-level requirement for ensuring the functional safety of the vehicle control system and may provide the basis for designing detailed diagnostic logic, error detection algorithms, and fail-safe mechanisms in subsequent development stages.

Next, the TARA procedure and its relationship to cybersecurity are described.

The data related to the plurality of asset elements, that is, the asset to be protected, the functionality of the asset, and the property of the asset, may be defined as common data that are commonly referenced in both HARA and TARA. In this case, the functionality of the asset corresponds to the functionality of the vehicle, and the safety hazard caused by a malfunction of a vehicle function may be evaluated in association with the security risk caused by a compromise of the asset functionality.

Specifically, each asset element may include the following items.

The asset may be a physical or logical component within the system that requires protection, such as information including vehicle diagnostic data or control signals. The functionality of the asset may be an operation performed by the asset or a service provided by the asset, such as reading or writing vehicle diagnostic data. The property of the asset may be characteristic information such as the communication interface to which the asset belongs, the direction of data flow, or the level of access authorization. For example, the property may be defined as “transmitting data to an external device through an internal communication network.”

The asset element data as described above may be used as input information for evaluating the cybersecurity properties of an asset from the perspective of TARA. For example, the cybersecurity properties of an asset may be defined as one or more of confidentiality, integrity, or availability, and the property that requires protection may vary depending on the characteristics of each asset.

For instance, for certain data services within the vehicle, such as the function of reading vehicle diagnostic data, the data may be accessible by an external device, and therefore confidentiality may be designated as the primary security property to prevent information leakage. Through such analysis, the system may define potential damage scenarios, such as “information leakage,” based on the property information of the asset and set corresponding security measures.

Meanwhile, the data related to the asset elements may be commonly referenced not only in TARA but also in HARA. For example, while the “read data request function” of the vehicle may be analyzed as a security risk factor related to external access in TARA, the same function may be evaluated as a malfunction in HARA that may pose a safety hazard to the system. Therefore, even when referring to the same asset, depending on its functionality and property, it may be analyzed as an interrelated risk factor from both safety and security perspectives.

According to an embodiment, the system may identify predicted threat scenario by analyzing the plurality of asset elements. In other words, by analyzing information about the various asset components within the vehicle, the system may identify situations that could lead to security vulnerabilities or external attacks in advance. For example, when an internal diagnostic data processing function of the vehicle is defined as a “Read Data” functionality and the function is structured to transmit data to an external diagnostic device through the in-vehicle communication network, the system may evaluate whether there is a risk of data leakage in this process. For instance, if the security of the function is insufficiently reinforced or if authentication procedures are missing along the communication path, there may be a possibility that an external entity could access the in-vehicle data without authorization. Accordingly, the system may identify such a case as an information-leakage-type predicted threat scenario.

In addition, the system may analyze the relationships among multiple assets to derive new threat scenarios through the interconnected functions or data flows. For example, when one asset performs a “data request” function and another asset performs a “data response” function, the system may recognize potential attacks such as message modification, spoofing, or replay within the communication section between the two assets as new threat scenarios.

As such, the system of the present invention may automatically derive predicted threat scenario at the system level by analyzing the relationships among the functionalities, communication paths, and cybersecurity properties of the plurality of asset elements, beginning from asset-level damage scenarios.

According to an embodiment, an impact scenario may be derived based on the target hazard scenario and the predicted threat scenario. The impact scenario may represent quantitative or qualitative data that describe the impact on the overall system, vehicle functions, driver, or external environment when a particular hazard or threat actually occurs. For example, when the target hazard scenario is “unintended rapid acceleration of the vehicle” caused by a malfunction of the “acceleration request function,” the system may derive an impact scenario such as “loss of driver control or increased probability of collision due to unintended rapid acceleration of the vehicle.”

As another example, when the predicted threat scenario is “information leakage caused by a loss of confidentiality of the diagnostic data request function (ReadData service),” the system may define an impact scenario such as “a situation in which internal diagnostic data or configuration information of the vehicle may be exposed externally, leading to a security breach.” In this case, the threat type may be classified as “information leakage,” and the extent of confidentiality loss may serve as a key evaluation factor for the corresponding impact scenario.

Based on the derived impact scenario, the system may classify the degree to which each hazard or threat affects the overall system. In addition, the impact scenario may be used as common data linking the results of hazard analysis (HARA) and the results of threat analysis (TARA). That is, by integrating the safety-related impact derived from the target hazard scenario and the security-related impact derived from the predicted threat scenario into a single impact scenario dataset, the system may comprehensively analyze the mutual influence between safety and security. In this manner, the system of the present invention may predict the impacts that may arise from situations respectively derived from hazards and threats and may store the corresponding analysis results in the database.

According to an embodiment, the impact scenario may be derived by analyzing the malfunctioning function among the plurality of functional elements identified in the target hazard scenario, evaluating the hazardous state caused by the malfunction, and finally simulating the actual influence of the hazardous state on the driver or the vehicle system.

More specifically, the system may analyze the role, behavior path, and interrelationships of each functional element by referring to the target hazard scenario data stored in the database. For example, although the “acceleration request” function of the vehicle normally operates to request an appropriate level of driving torque based on the driver's pedal input, when a malfunction occurs in this function, the system may detect the abnormal condition in which “an excessive acceleration torque beyond the requested level is being demanded.”

When the system detects such a functional malfunction, the system may evaluate the hazardous state that may occur due to the malfunction. For example, when an excessive acceleration request causes the vehicle to move forward regardless of the driver's intention, the system may define this condition as a hazardous state of “unintended longitudinal acceleration of the vehicle.” Thereafter, the system may analyze, through simulation, the influence that the hazardous state may have on the driver and the vehicle. For instance, by inputting variables such as vehicle speed, road conditions, distance to the preceding vehicle, and driver reaction time, the system may evaluate the outcomes that the hazardous state may produce in actual driving environments.

Through such simulation, results such as “the vehicle moving forward in an uncontrollable state,” “increased probability of collision due to a reduction in distance to the preceding vehicle,” and “inability to avoid a collision within the driver's steering or braking reaction time” may be derived. The system may comprehensively analyze the simulation results to determine the influence of the hazardous state on driver safety, vehicle control stability, and occupant protection level, and may define such results as the impact scenario.

According to an embodiment, an attack path may be generated based on at least one of a safety element, a financial element, an operational element, and a privacy element with respect to the impact scenario. Specifically, the system may analyze the data included in the impact scenario to identify the pathway through which a particular threat may infiltrate and propagate within the vehicle system, and may derive the specific attack path accordingly. For example, when the impact scenario is “information leakage caused by a loss of data confidentiality within the in-vehicle network,” the system may analyze the interconnection structure of the assets within the vehicle and derive possible paths through which an attacker may gain access using an external device such as a diagnostic tool, communication module, or gateway.

The generation of the attack path may be performed from various viewpoints depending on the characteristics of the impact scenario. For instance, from the perspective of a safety element, the system may define pathways through which an attack or threat may affect safety-related functions such as driving stability, braking systems, or steering systems, and may identify possible routes by which such functions may malfunction or be manipulated. For example, when a particular ECU is compromised and the brake control signal is altered, a series of intrusion steps may be identified as an attack path.

According to an embodiment, the safety element may be derived from the safety level. That is, based on the safety level determined by evaluating the exposure, severity, and controllability of the target hazard scenario, the system may determine the level of safety required for each function within the vehicle system. For example, when a function has a high safety level, its malfunction is more likely to directly affect driver safety or vehicle control, and the system may identify such a function as a major safety element and configure additional protective measures to be applied to the system that includes the function.

The financial element is an element that considers the possibility of economic loss resulting from an attack or threat. For example, pathways by which paid communication service data, over-the-air (OTA) update information, or vehicle payment systems may be compromised may be defined as financial elements.

The operational element represents pathways through which functions may be interrupted or may operate abnormally during the operation of the vehicle or the provision of vehicle services. For instance, when access through a remote control system or diagnostic equipment for maintenance is blocked or restricted, the system may identify such cases as attack paths corresponding to operational disruption.

Privacy element is an element that defines pathways through which sensitive information stored in the vehicle, such as driver data, passenger information, or driving history, may be leaked externally. For example, a situation in which vehicle log data may be transmitted without authorization through an external communication module may be evaluated as an attack path that includes a privacy element.

Each of the above elements may be evaluated independently or may be combined to form a composite attack path. For example, a composite attack path involving both privacy leakage and operational disruption may be defined as a path in which an external attacker exfiltrates diagnostic data through a vehicle communication interface while simultaneously disabling communication functions, thereby preventing the transmission of normal control signals.

The system may store the derived attack paths in the database and may calculate a risk value by comprehensively evaluating, for each path, factors such as attack feasibility, attack difficulty, and the potential level of impact. The calculated risk value and the associated evaluation results may be used as the basis for establishing the security goals and may be used to identify, derive, and prioritize appropriate security control measures and alternative security measures for each attack path.

According to an embodiment of the present invention, the system may derive one or more attack paths based on the impact scenario and may evaluate the attack feasibility and the impact rating for each derived attack path, thereby calculating the final risk value. The calculated risk value may be used for establishing the security goals and selecting security countermeasures according to priority.

The system may evaluate the attack feasibility for each attack path, and the evaluation may be composed of multiple detailed elements. For example, elapsed time may represent the time required to complete the attack, specialist expertise may represent the level of technical proficiency required to perform the attack, knowledge of the item or component may represent the attacker's understanding of the system, protocol, or interface, window of opportunity may represent the temporal or environmental conditions under which the attack is possible, and equipment may represent the physical or software tools required to execute the attack.

The system may assign qualitative or quantitative scores to each of the above elements and may calculate the attack feasibility value through weighted summation, rule-based evaluation, or arithmetic combination. The system may combine the calculated attack feasibility value and the impact rating to derive the risk value for each attack path.

The derived risk value may subsequently be used for prioritizing security countermeasures, setting security goals, and selecting specific control measures during the design and operational stages. The system may store the attack feasibility value, the impact rating, the risk value, and associated metadata for each attack path in the database and may perform the following subsequent operations based on these stored values.

The system may determine the priority of security countermeasures for each attack path based on the calculated risk value and may recommend appropriate countermeasures or present the results for manual review. The system may also review the consistency between the determined safety level and the security goals and may analyze and resolve potential conflicts between safety requirements and security requirements. In addition, by mapping appropriate security control measures and alternative security measures for each attack path, the system may derive and manage specific response measures for the identified risks.

According to an embodiment of the present invention, the system may set the security goals of the vehicle based on the derived attack paths and the predicted threat scenario. In an embodiment, the security goals may be set to satisfy the required levels of integrity and availability defined by the safety goals. In addition, during the process of establishing the security goals, the system may not merely identify risks but may also consider the characteristics of each risk and the interdependencies within the vehicle system, thereby defining corresponding security control measures such as access control, encrypted communication, and data integrity verification. The security goals set in this manner may be applied throughout the entire design and operational phases of the vehicle system so that specific attack paths are blocked in advance or, even if a threat is realized, the system may be configured to return to a safe state.

Furthermore, the system may review the consistency between the set security goals and the safety goals and may adjust them in a complementary manner to ensure that conflicts do not occur between the security requirements and the safety requirements. Through this process, the vehicle system may maintain an integrated and consistent risk management framework in both functional safety (HARA) and cybersecurity (TARA).

According to an embodiment, based on the security goals, security control measures and alternative security measures required to satisfy the conditions of the safe state may be determined. For identical or similar target hazard scenarios or predicted threat scenario, the results of applying the security control measures and the results of applying the safety mechanisms may be linked to each other and managed in an integrated manner within the database. In addition, the results of such risk evaluation and mitigation may serve as reference information for subsequent tracking and risk reassessment, thereby ensuring the continuous cybersecurity and safety of the system.

As a result, the step of establishing the security goals according to the present invention may define a required security level (SG Level) for protecting critical assets within the vehicle based on the analysis results of the attack paths and predicted threat scenario. Appropriate security control measures and alternative response procedures may then be derived according to the defined security requirement level, thereby enhancing the overall cybersecurity reliability of the vehicle and implementing a comprehensive integrated risk management framework that unifies safety and security.

Hereinafter, the common data in the relationship diagram of the safety hazards and security threats in FIG. 2 will be described.

In the system according to an embodiment of the present invention, the common data serves as key reference data for linking functional safety analysis (HARA) and cybersecurity analysis (TARA), and ensures data consistency and analytical continuity between the two assessment frameworks. Here, the functional safety analysis may correspond to hazard analysis and risk assessment according to the KSA translation standard. The cybersecurity analysis may correspond to threat analysis and risk assessment according to the KSA translation standard.

Specifically, the common data may include information regarding the vehicle functions, malfunctions of the functions, assets, functionalities of the assets, and properties of the assets. Such common data may be used as input values for function-level hazard assessment from the HARA perspective, and as input values for asset-level threat assessment from the TARA perspective. That is, although the same system component is defined as a function in HARA and evaluated as a source of safety hazard, the same component may be defined as an asset in TARA and evaluated as a target exposed to external cyberattacks.

For example, the vehicle's acceleration control function (Requesting Acceleration) may, from the HARA perspective, cause a functional malfunction such as requesting excessive acceleration torque and consequently form a hazard scenario such as unintended longitudinal acceleration. The same function may be defined as an asset responsible for transmitting acceleration control signals from the TARA perspective, and if an external attacker compromises the integrity of such control signals or forges the signals, the same unintended acceleration state may occur. Therefore, the functional malfunction defined in HARA and the asset-level threat defined in TARA may be cross-referenced and linked through the common data based on the same functional element.

Another example of the linkage based on the common data can be found in the relationship between a hazard scenario in HARA and a predicted threat scenario in TARA. For instance, if HARA analysis derives a hazard scenario in which a sensor malfunction causes a vehicle control error, the same sensor asset may correspond to a predicted threat scenario in TARA such as manipulation of sensor data. The system may map the correspondence between the two scenarios in the common database and compare or adjust the hazard risk and threat value, thereby deriving a unified risk level for the same function or the same asset.

The common data may also serve as a key reference for maintaining the consistency and alignment between the safety goals derived from HARA and the security goals derived from TARA. For example, if HARA establishes a safety goal requiring that the acceleration control signal be cut off within 500 ms, TARA may establish a security goal requiring encryption and authentication of the acceleration control signal to ensure its integrity along the same signal path. In this case, both goals reference the same common data item and operate in a complementary manner to secure both functional safety and cybersecurity of the vehicle.

Further, the system according to the present invention may include a bidirectional data update mechanism that enables the results of HARA and TARA to be cross-updated through the common database. For example, when TARA analysis evaluates that a certain communication interface has a high attack feasibility, the system may increase the exposure value of the hazard scenario associated with that interface in HARA. Conversely, when HARA evaluates that the controllability of a specific function is low, TARA may raise the priority level for protecting the corresponding asset. Through such a feedback mechanism, the system may continuously complement the results of HARA and TARA based on the common data and maintain an integrated risk profile that reflects both hazards and threats in real time.

In this manner, the common data functions as a data bridge that links the analytical results of functional safety and cybersecurity, thereby enabling cross-reference and integrated evaluation between the two analytical procedures. As a result, the common-data-based cross-reference structure according to the present invention ensures data consistency between HARA and TARA and provides an integrated risk-management framework in which safety and security do not conflict with each other but instead operate in a complementary and coherent manner.

FIG. 3 is a diagram exemplifying common data for safety hazards and security threats according to the embodiment of FIG. 2.

Referring to FIG. 3, information and data required for establishing safety goals or security goals for vehicle risk are shown. In FIG. 3, the data used for establishing the safety goals may be referred to as hazard data, which may correspond to HARA-exclusive data. The data used for establishing the security goals may be referred to as threat data, which may correspond to TARA-exclusive data. Meanwhile, the data commonly referenced in both HARA and TARA, that is, the hazard data and the threat data, may be referred to as common data.

The hazard data referenced only in HARA may include information regarding the plurality of functional elements. The plurality of functional elements may include sub-data relating to the vehicle functions, malfunctions of the functions, and hazardous states that may occur due to the malfunctions. In this case, the data relating to the vehicle functions, functional malfunctions, and hazardous states may be the common data referenced by both HARA and TARA.

The threat data referenced in TARA may include information regarding a plurality of asset elements. The information regarding the plurality of asset elements may include sub-data concerning the assets, functionalities of the assets, and properties of the assets. In this case, the data relating to the assets, asset functionalities, and asset properties may be the common data referenced by both HARA and TARA.

The common data relating to the target hazard scenario may serve as the hazard data referenced in HARA and may be derived based on a combination of the hazard situation elements, vehicle operating modes, operational situations, and environmental conditions. For example, the hazard situation elements define the types of hazards that may occur when a functional malfunction arises, the vehicle operating mode distinguishes the driving state in which the function is performed, and the operational situation and environmental condition determine the degree of hazard according to external conditions. Through the combination of these factors, a target hazard scenario that may occur under a specific operating condition can be derived.

The common data relating to the safety level may correspond to data regarding the ASIL (Automotive Safety Integrity Level). For example, the safety level may be determined based on data relating to the exposure of the hazardous situation, the severity of the hazardous situation, and the controllability of the hazardous situation. Here, the data relating to exposure, severity, and controllability may correspond to hazard data referenced only in HARA. The safety goal may be derived based on the safety level data, which is the common data referenced in both HARA and TARA.

The common data relating to the impact scenario may represent data regarding potential impacts that may be derived from the expected threat scenarios. Referring to FIG. 3, the data relating to the impact scenario may include sub-data regarding safety elements, operational elements, financial elements, and privacy elements. In other words, the impacts from the expected threats may indicate the level of loss or damage associated with safety, financial aspects, operational aspects, and privacy aspects. The data relating to the impact scenario may also serve as the basis for quantifying, in the event of a threat scenario, the functional, financial, operational, or privacy-related impacts on the vehicle. Here, the data relating to the safety element may correspond to common data that can be derived based on the safety level. The data relating to the operational element, financial element, and privacy element may correspond to threat data referenced only in TARA.

The common data relating to the security goals may be derived based on at least one of the common data or the threat data. For example, by analyzing the expected threat scenarios and the attack paths referenced only in TARA, the impacts of the threats on the vehicle's assets, functions, or services may be evaluated, and based on the evaluation result, the security goals for ensuring the integrity, availability, confidentiality, and authentication of the vehicle system may be established.

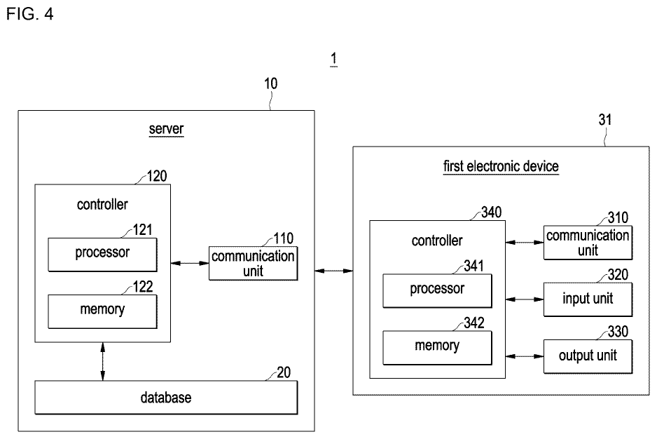

FIG. 4 is a block diagram of a vehicle risk-integrated management system according to an embodiment.

Referring to FIG. 4, the server 10 of the vehicle risk-integrated management system 1 may include a database 20, a communication unit 110, and/or a controller 120.

The database 20 may store information and data required to establish safety goals or security goals for vehicle risks. For example, the data used for establishing the safety goals may be referred to as hazard data. The hazard data may correspond to HARA-exclusive data or data commonly referenced by both TARA and HARA. The data used for establishing the security goals may be referred to as threat data. The threat data may correspond to TARA-exclusive data or data shared between TARA and HARA.

The database 20 may store at least some of the preset plurality of hazard data required for performing HARA during the vehicle risk-management process. For example, the database 20 may store HARA-exclusive data. The HARA-exclusive data may be composed of a plurality of data items that represent respective sequential steps of a preset HARA procedure. The HARA-exclusive data may also include at least one piece of sub-data.

The database 20 may store at least some of the preset plurality of threat data required for performing TARA during the vehicle risk-management process. For example, the database 20 may store TARA-exclusive data. The TARA-exclusive data may be composed of a plurality of data items that represent respective sequential steps of a preset TARA procedure. The TARA-exclusive data may also include at least one piece of sub-data.

The database 20 may store a preset plurality of common data that are commonly referenced in both the HARA process and the TARA process. For example, the database 20 may store the common data illustrated in FIGS. 2 and 3, which are referenced in both HARA and TARA.

Meanwhile, at least some of the hazard data, threat data, the sub-data thereof, and the common data may have a hierarchical structure in which the data items are dependent on or associated with each other, and an update or modification of a specific data item may be linked to an update of other related data items.

The database 20 may store connection-relationship information that defines hierarchical relationships among the HARA-exclusive data, that is, the hazard data according to the sequential phases of HARA.

The database 20 may store connection-relationship information that defines hierarchical relationships among the TARA-exclusive data, that is, the threat data according to the sequential phases of TARA.

The database 20 may store connection-relationship information that represents the stepwise or hierarchical relationships among the common data commonly referenced in both HARA and TARA.

The database 20 may store interconnection-relationship information among the hazard data, the threat data, and the common data. For example, the database 20 may store connection-relationship information that allows at least one of the HARA-exclusive data and the common data referenced in both HARA and TARA to have a hierarchical reference relationship. The database 20 may also store connection-relationship information that enables at least one of the TARA-exclusive data and the common data referenced in both HARA and TARA to form a linked or referenceable hierarchical structure.

The communication unit 110 may establish a communication channel between the server 10 and external devices, for example the first through fifth electronic devices 31, 32, 33, 34, and 35 illustrated in FIG. 1, and may transmit and receive data through the established communication channel. The communication unit 110 may include a communication circuit and a control circuit configured to control the operation of the communication circuit in order to support such communication functions.

For example, the communication unit 110 may include a wireless communication module such as a cellular communication module, a Wi-Fi communication module, a short-range wireless communication module, or a global navigation satellite system communication module, and/or a wired communication module, and may transmit and receive data with external devices through the corresponding module.

The controller 120 may be electrically connected to each component of the server 10, for example the database 20 and the communication unit 110, and may control each component.

The controller 120 may control the database 20 to store HARA-exclusive data, TARA-exclusive data, and common data of HARA and TARA.

The controller 120 may be communicatively connected to the electronic devices 31, 32, 33, 34, and 45 through the communication unit 110. Although only one first electronic device 31 is illustratively shown in FIG. 4, this is merely for explanation, and the capability to communicate with multiple electronic devices does not limit the scope of the present invention.

The controller 120 may receive a user ID from the first electronic device 31 and may set and assign user permissions for the electronic device 31 based on the received user ID.

The controller 120 may receive evaluation target information corresponding to a vehicle asset or vehicle function from the first electronic device 31 through the communication unit 110.

In response to receiving the evaluation target information, the controller 120 may generate and output HARA and/or TARA result data for the evaluation target information based on the HARA-exclusive data, the TARA-exclusive data, and/or the common data of HARA and TARA.

The controller 120 may generate HARA and/or TARA result data for the evaluation target information, based on user input information (or user data) for at least a portion of the HARA-exclusive data, the TARA-exclusive data, and/or the common data of HARA and TARA received through the communication unit 110. For example, the user input information may include a user-configured value for the corresponding data, that is, a parameter. The controller 120 may generate HARA and/or TARA result data corresponding to the evaluation target information based on a designated template for HARA (for example a dynamic template) and/or a designated template for TARA (for example a dynamic template) stored in the memory 122. The generated HARA and/or TARA result data may be transmitted to the first electronic device 31 through the communication unit 110.

The controller 120 may identify data among the HARA and/or TARA result data that is preset to be included in an FSM document, and may generate FSM document data based on a designated FSM template (for example a dynamic template) stored in the memory 122, and may output the generated FSM document data. The generated FSM document data may also be transmitted to the electronic device 31 through the communication unit 110.

The controller 120 may include a control circuit configured to control the performance of the above functions.

The controller 120 may be implemented as a micro control unit (MCU) and may include the memory 122 and a processor 121.

The memory 122 may store programs and/or data for processing each piece of data (for example data received from external devices such as the first through fifth electronic devices 31, 32, 33, 34, and 35 shown in FIG. 1).

The memory 122 may temporarily store each piece of data or may temporarily store the processing result of data processed by the processor 121.

The memory 122 may include volatile memory such as S-RAM or D-RAM as well as non-volatile memory such as flash memory, ROM, EPROM, and/or EEPROM.

The processor 121 may process each piece of received data and may output signals for controlling the communication unit 110 and/or the database 20 based on the processing result.

The first electronic device 31 may include a communication unit 310, an input unit 320, an output unit 330, and a controller 340.

The communication unit 310 may establish a communication channel between the first electronic device 31 and an external device, for example the server 10, and may transmit and receive data through the established communication channel. The communication unit 310 may include a communication circuit and a control circuit configured to control operation of the communication circuit.

For example, the communication unit 310 may include a wireless communication module such as a cellular communication module, a Wi-Fi communication module, a short-range wireless communication module, or a global navigation satellite system communication module, and/or a wired communication module, and may transmit and receive data with an external device through the corresponding communication module.

The input unit 320 may receive information according to a user operation and may provide the information to a connected device such as the controller 340.

For example, the input unit 320 may include input means such as buttons, switches, a touchscreen, and/or a microphone.

The output unit 330 may output visual and/or auditory information so that a user of the first electronic device 31 can perceive the information. For example, the output unit 330 may include a display and/or a speaker.

The controller 340 may be electrically connected to each component of the first electronic device 31, for example the communication unit 310, the input unit 320, and/or the output unit 330, and may control operations of the respective components.

The controller 340 may communicate with the server 10 through the communication unit 310. The controller 340 may receive a service for integrated management of HARA and TARA documents from the server 10 through the communication unit 310.

For example, the controller 340 may receive at least a portion of the HARA-exclusive data, the TARA-exclusive data, and/or the common data of HARA and TARA from the server 10, and may output the received data through the output unit 330, for example a display.

The controller 340 may acquire evaluation target information corresponding to a vehicle asset or function according to a user operation through the input unit 320.

The controller 340 may acquire user input information, for example a parameter, through the input unit 320 for at least a portion of the HARA-exclusive data, the TARA-exclusive data, and/or the common data of HARA and TARA.

The controller 340 may transmit the user input information acquired through the input unit 320 to the server 10 through the communication unit 310 for at least a portion of the HARA-exclusive data, the TARA-exclusive data, and/or the common data of HARA and TARA.

The controller 340 may receive HARA and/or TARA result data for the evaluation target information from the server 10 through the communication unit 310, and may output the received result data to the user through the output unit 330, for example a display.

In addition, the controller 340 may receive result data for the FSM document from the server 10 through the communication unit 310 and may output the data through the output unit 330, for example a display.

Meanwhile, the controller 340 may include a control circuit.

The controller 340 may be implemented as a micro control unit (MCU; Micro Control Unit) and may include a memory 342 and/or a processor 341.

The memory 342 may store programs and/or data for processing each piece of data, for example data received from an external device such as the server 10 or data corresponding to information input through the input unit 320.

The memory 342 may temporarily store received data or may temporarily store results of data processed by the processor 341.

The memory 342 may include volatile memory such as S RAM and/or D RAM, and non volatile memory such as flash memory, ROM (Read Only Memory), EPROM (Erasable Programmable Read Only Memory), and/or EEPROM (Electrically Erasable Programmable Read Only Memory).

The processor 341 may process each received or input piece of data and may provide control signals to the respective components in order to control the communication unit 310, the input unit 320, and the output unit 330 based on the processing result.

Although not shown in FIG. 4, the second electronic device 32, the third electronic device 33, the fourth electronic device 34, and the fifth electronic device 35 of FIG. 1 may include a communication unit, an input unit, an output unit, and a controller similar to those of the first electronic device 31, and may perform operations similar to those of the first electronic device 31.

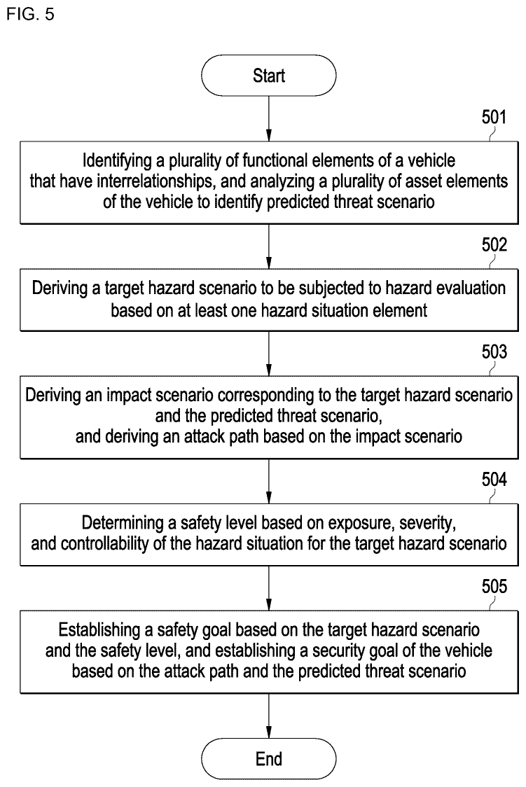

FIG. 5 is a flowchart illustrating a control operation procedure of a server according to an embodiment.

Referring to FIG. 5, the server may identify a plurality of functional elements of the vehicle that have interrelationships and may analyze a plurality of asset elements of the vehicle to identify predicted threat scenario (501).

According to an embodiment, the plurality of functional elements may be HARA related data concerning functional safety and may include at least one of the vehicle function, a malfunction of the function, and a hazardous state caused by the malfunction. Here, the data regarding the vehicle function, the malfunction of the function, and the hazardous state that may occur due to the malfunction may be data commonly referenced by both HARA and TARA.

According to an embodiment, the plurality of asset elements may be TARA related data concerning cybersecurity and may include an asset to be protected, a functionality of the asset, and a property of the asset. Here, the data regarding the asset, the functionality of the asset, and the property of the asset may be data commonly referenced by both HARA and TARA.

An asset may be a physical or logical component within the system that needs to be protected and may be information such as vehicle diagnostic data or control signals. The functionality of the asset may be an operation performed by the asset or a service provided by the asset, for example reading or writing vehicle diagnostic data. The property of the asset may be characteristic information such as the communication interface to which the asset belongs, the transmission direction of the data, or the access permission level. The functionality of the asset may correspond to the vehicle function, and a safety hazard caused by a malfunction of the vehicle function may correspond to a security risk caused by a compromise of the functionality of the asset.

The server may derive a target hazard scenario to be evaluated for risk assessment based on at least one hazard situation element (502). For example, the target hazard scenario may be derived by modeling representative operational situations that may occur during vehicle driving. According to an embodiment, the target hazard scenario may be derived by combining at least one hazard situation element concerning the vehicle operating mode, operational situation, and environmental condition and excluding combinations that are contradictory among the combined hazard situation elements. The combination and exclusion conditions among vehicle operating mode, operational situation, and environmental condition may be referred to in the description of FIG. 2 above.

The server may derive an impact scenario based on the target hazard scenario and the predicted threat scenario and may further derive an attack path based on the impact scenario (503). The impact scenario represents data describing, quantitatively or qualitatively, the effect on the overall system, vehicle functions, the driver, or the external environment when a specific hazard or threat actually occurs. In addition, the impact scenario may be used as common data linking the results of hazard analysis (HARA) and threat analysis (TARA).

In one embodiment, the impact scenario may be derived by analyzing the malfunction of a function among the plurality of functional elements identified in the target hazard scenario, evaluating the hazardous state caused by the malfunction, and simulating the effect of the hazardous state on the driver or the vehicle.

In one embodiment, the attack path may be generated based on at least one of the safety element, financial element, operational element, and privacy element associated with the impact scenario. Here, the safety element may be derived from the safety level. Specifically, the server may analyze the data contained in the impact scenario to determine the path through which a given threat can infiltrate and propagate within the vehicle system, and derive a concrete attack path accordingly.

The server may determine the safety level based on an exposure, a severity, and a controllability of the hazardous situation associated with the target hazard scenario (504). For the derived target hazard scenario, the safety level (ASIL) may be determined based on the exposure (E), severity(S), and controllability (C) of the hazardous situation. In one embodiment, the safety level may be determined by evaluating the exposure, severity, and controllability of the hazardous situation according to predefined criteria and combining the evaluation results.

The server may establish the safety goal based on the target hazard scenario and the safety level, and may set security goal of the vehicle based on the attack path and the predicted threat scenario (505).

Specifically, in the present embodiment, the safety goal may be established as a criterion for preventing hazardous situations that may occur due to malfunctions of vehicle functions in advance, or for minimizing injury to persons and damage to the system even if such hazards occur.

In one embodiment, the security goal may be set to satisfy the required level of integrity and availability demanded by the safety goal. In addition, during the process of establishing the security goal, the server may not merely identify risks but also consider the characteristics of each risk and the interdependencies within the vehicle system, and define corresponding security control measures such as access control, encrypted communication and data integrity verification.

In one embodiment, based on the security goal, security control measures and alternative security measures for satisfying the conditions of the safe state may be determined.

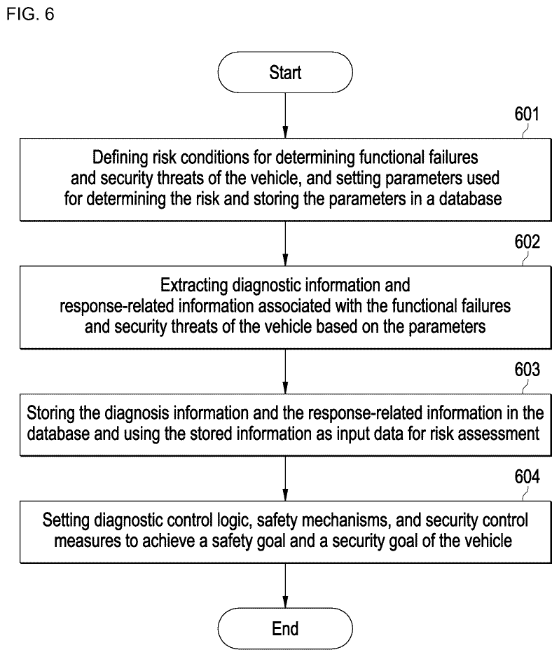

FIG. 6 is a flowchart illustrating a control procedure of a server for achieving vehicle safety goals and security goals according to an embodiment.

Referring to FIG. 6, the server may define risk conditions for determining functional failures and security threats of the vehicle and set parameters used for determining such risks, and store them in the database (601). For example, from the functional perspective, the server may set parameters including failure occurrence conditions, thresholds and normal operating ranges, and from the security perspective, may set security-related parameters such as abnormal communication patterns, the number of access failures, authentication errors and changes in message periodicity, thereby constructing reference information for comprehensively determining potential risk occurrences in the vehicle system.

The server may extract diagnostic information and response-related information associated with functional failures and security threats of the vehicle based on the parameters used for determining the vehicle risks (602). The server may analyze various operational data collected inside the vehicle, including sensor data, control commands, communication logs, authentication results and system response characteristics, thereby determining functional failure conditions and signs of security threats, and deriving response actions for each risk, such as generating warnings, restricting functions, blocking access and switching to a protection mode. In addition, the server may extract and structure supplementary data, such as the occurrence time of the failure or threat, occurrence frequency, impact range, attack attempt patterns, failure duration and the effectiveness of applied countermeasures, thereby providing high-reliability analytical information that can be used in subsequent risk assessment processes.

The server may store the diagnostic information and response-related information associated with the vehicle risks in the database and use them as input data for risk evaluation (603). For example, the server may record not only the determination results of functional failures or security threats but also various analytical data such as the occurrence time of the risk, frequency, impact range, system state changes, attack attempt patterns, failure duration and the applied response actions and their effectiveness, in a structured form. Furthermore, the server may classify and index such data according to risk type so that the information can reliably serve as evidence for determining risk levels from the perspective of functional safety (HARA) or cybersecurity (TARA) in subsequent analysis stages. Through this, the server can provide a foundation enabling quantitative or qualitative data-driven analysis during risk assessment and management across the vehicle system.

The server may set diagnostic control logic, safety mechanisms and security management measures for achieving the safety goal and the security goal of the vehicle (604). The server may distribute or update such control logic and mechanisms in association with the vehicle controller or network gateway and may automatically adjust configuration values through real-time data feedback.

According to one embodiment, for identical or similar target hazard scenario or predicted threat scenario, the server may match the application results of the security management measures with the application results of the safety mechanisms and manage them in an integrated manner within the database.

For example, for the same situation of unintended acceleration, if the HARA analysis applies a safety mechanism of blocking the acceleration control signal within 500 ms, and the TARA analysis applies a security management measure of encrypting and authenticating the acceleration control signal, the server may map both results to the same common data item (for example, the acceleration control signal) and manage them accordingly.

Through this structure, the server may mutually reference the results of HARA and TARA and maintain consistency between the functional safety measures and the security measures, thereby implementing an integrated risk management framework in which both safety and security of the vehicle are simultaneously satisfied.

Meanwhile, in the embodiments described above, common elements of TARA and HARA were identified so that risks that are predictable from the perspective of functional safety during vehicle operation and asset protection can be identified, and activities for mitigating such risks can be performed. In addition, the embodiments presented an integrated framework that unifies detailed procedures so that risk management activities can be conducted without information loss. This unified framework eliminates waste and duplication of resources that may occur when functional safety and cybersecurity are separately performed and maintained. The effectiveness of this approach was verified through the example of a vehicle braking system, demonstrating improvements in the efficiency of the risk management procedure.

In addition, the embodiments focused on identifying the mutual relationship centering on the integration of TARA and HARA and unifying the risk mitigation activities through the identified security management measures and safety mechanisms. However, the quality of risk mitigation results may vary depending on the granularity of design and analysis. Therefore, tools such as fault tree analysis, attack path analysis and failure mode and effects analysis may be expanded and incorporated into the integrated framework for functional safety and cybersecurity described in the embodiments above.

In another aspect, the disclosed embodiments may be implemented in the form of a recording medium storing instructions that are executable by a computer. The instructions may be stored as program code and, when executed by a processor, may generate program modules that perform the operations of the disclosed embodiments. The recording medium may be implemented as a computer-readable recording medium.

The computer-readable recording medium includes any type of medium in which instructions that can be interpreted by a computer are stored. Examples include read only memory (ROM), random access memory (RAM), magnetic tapes, magnetic disks, flash memory, and optical data storage devices.

The machine-readable storage medium may be provided as a non-transitory storage medium. The term “non-transitory” merely indicates that the storage medium is a tangible device that does not include signals such as electromagnetic waves, and does not distinguish whether data is stored permanently or temporarily. For example, a non-transitory storage medium may include a buffer in which data is stored temporarily.

The disclosed embodiments have been described above with reference to the accompanying drawings. It will be understood by those skilled in the art that various modifications and other embodiments may be made without departing from the technical spirit or essential characteristics of the present invention. The disclosed embodiments are therefore to be regarded as illustrative and not restrictive.

What is claimed is:

1. A vehicle risk management method comprising:
identifying a plurality of functional elements of the vehicle that have interrelationships, and analyzing a plurality of asset elements of the vehicle to identify predicted threat scenario;
deriving a target hazard scenario to be subjected to hazard evaluation based on at least one hazard situation element;
deriving an impact scenario corresponding to the target hazard scenario and the predicted threat scenario, and deriving an attack path based on the impact scenario;
determining a safety level based on an exposure, a severity, and a controllability of the hazard situation for the target hazard scenario; and
establishing a safety goal based on the target hazard scenario and the safety level, and establishing a security goal of the vehicle based on the attack path and the predicted threat scenario.

2. The method of claim 1,
wherein the target hazard scenario is derived by combining the at least one hazard situation element related to an operating mode, operational situation, and environmental condition of the vehicle, and excluding contradictory combinations among the combined hazard situation elements.

3. The method of claim 1,
wherein the plurality of functional elements includes at least one of a function of the vehicle, a malfunction of the function, and a hazardous state that may occur due to the malfunction.

4. The method of claim 3,
wherein the plurality of asset elements includes an asset to be protected, a function of the asset, and a property of the asset,
wherein the function of the asset corresponds to the function of the vehicle, and a safety hazard caused by a malfunction of the function of the vehicle corresponds to a security risk caused by the compromise of the function of the asset.

5. The method of claim 3,
wherein the impact scenario is derived by analyzing the malfunction of the function among the plurality of functional elements identified in the target hazard scenario, evaluating the hazardous state caused by the malfunction, and simulating the influence of the hazardous state on driver or the vehicle.

6. The method of claim 1,
wherein the attack path is generated based on at least one of a safety element, a financial element, an operational element, and a privacy element for the impact scenario, and
wherein the safety element is derived from the safety level.

7. The method of claim 1,
wherein the safety level is determined by evaluating the exposure, severity, and controllability of the hazard situation according to predefined evaluation criteria and combining the results of the evaluations of the exposure, severity, and controllability.

8. The method of claim 1,
wherein the security goal is set to satisfy a required level of integrity and availability demanded by the safety goal.

9. The method of claim 1,
wherein, based on the security goal, security control measures and alternative security measures are determined to satisfy conditions of the safe state.

10. The method of claim 1,
further comprising setting diagnostic control logic, safety mechanisms, and security management measures to achieve the safety goal and the security goal of the vehicle,
wherein setting the diagnostic control logic comprises:
defining risk conditions for determining functional failures and security threats of the vehicle, setting parameters used for determining the risk, and storing the parameters in a database; and
extracting diagnostic information and response-related information associated with the functional failures and security threats of the vehicle based on the parameters, and storing the diagnostic information and the response-related information in the database to be used as input data for risk assessment.

11. The method of claim 10,
wherein, for identical or similar target hazard scenario or predicted threat scenario, an application results of the security management measures and the application results of the safety mechanisms are matched with each other and configured to be linked or managed in the database.

12. A database storing a plurality of data for vehicle risk management;
a communication module configured to communicate with an external device; and
a processor electrically or communicatively connected to the database and the communication module;
wherein the processor is configured to:
identify a plurality of functional elements of the vehicle that have interrelationships and analyze a plurality of asset elements of the vehicle to identify predicted threat scenario;
derive a target hazard scenario, which is subject to hazard evaluation, based on at least one hazard situation element;
derive an impact scenario corresponding to the target hazard scenario and the predicted threat scenario, and derive an attack path based on the impact scenario;
determine a safety level based on an exposure, a severity, and a controllability of the hazard situation for the target hazard scenario; and
establish a safety goal based on the target hazard scenario and the safety level, and establish a security goal based on the attack path and the predicted threat scenario.

13. The server of claim 12,
wherein the target hazard scenario is derived by combining the at least one hazard situation element related to an operating mode, operational situation, and environmental condition of the vehicle, and excluding contradictory combinations among the combined hazard situation elements.

14. The server of claim 12,
wherein the plurality of functional elements includes at least one of a function of the vehicle, a malfunction of the function, and a hazardous state that may occur due to the malfunction.

15. The server of claim 14,
wherein the plurality of asset elements includes an asset to be protected, a function of the asset, and a property of the asset, and
wherein the function of the asset corresponds to the function of the vehicle, and a safety hazard caused by a malfunction of the function of the vehicle corresponds to a security risk caused by the compromise of the function of the asset.

16. The server of claim 14,
wherein the impact scenario is derived by analyzing the malfunction of the function among the plurality of functional elements identified in the target hazard scenario, evaluating the hazardous state caused by the malfunction, and simulating the influence of the hazardous state on driver or the vehicle.

17. The server of claim 12,
wherein the attack path is generated based on at least one of a safety element, a financial element, an operational element, and a privacy element for the impact scenario, and
wherein the safety element is derived from the safety level.

18. The server of claim 12,
wherein the safety level is determined by evaluating the exposure, severity, and controllability of the hazard situation according to predefined evaluation criteria and combining the results of the evaluations of the exposure, severity, and controllability.

19. The server of claim 12,
wherein the processor is configured to:
set diagnostic control logic, safety mechanisms, and security management measures to achieve the safety goal and the security goal of the vehicle;
define risk conditions for determining functional failures and security threats of the vehicle, set parameters used for determining the risk, and store the parameters in the database;
extract diagnostic information and response-related information associated with the functional failures and security threats of the vehicle based on the parameters, and store the diagnostic information and the response-related information in the database to be used as input data for risk assessment, thereby setting the diagnostic control logic.

20. The server of claim 19,
wherein the processor is configured such that, for identical or similar target hazard scenario or predicted threat scenario, an application results of the security management measures and the application results of the safety mechanisms are matched with each other and linked or managed in the database.
